(19) United States
(12) Patent Application Publication
(10) Pub. No.: US 2016/0190801 A1
(43) Pub. Date: Jun. 30, 2016

(54) SCALABLE ENERGY STORAGE SYSTEM

(71) Applicant: Proterra Inc., Greenville, SC (US)

(72) Inventors: Seamus T. McGrath, Simpsonville, SC (US); Michael C. WALKER, Greenville, SC (US)

(21) Appl. No.: 14/586,349

(22) Filed: Dec. 30, 2014

(51) Int. Cl. H02J 1/00

(52) U.S. Cl. CPC H02J 1/00; H02J 2001/008

(57) ABSTRACT

A scalable energy storage system may comprise a plurality of battery packs including at least a first battery pack and a second battery pack. The system may also include a plurality of inverters. The plurality of inverters may include at least a first inverter and a second inverter. The plurality of battery packs may be electrically coupled to the plurality of inverters such that the first battery pack is individually connected to an input of the first inverter and the second battery pack is individually connected to an input of the second inverter.

### TECHNICAL FIELD

The current disclosure relates to systems and methods for scalable energy storage. In particular, the current disclosure relates to reducing the sensitivity of scalable energy storage systems to battery health.

### BACKGROUND

An energy storage system typically includes a plurality of batteries or other energy storage devices coupled together to provide electric power for an application. The total energy of the system may be scaled up or down by increasing or decreasing the number of batteries of the system. Energy storage systems may be used in any mobile or stationary application (providing power to electric vehicles, buildings, machines, etc.). In some applications, an energy storage system may be coupled to an electrically powered installation connected to the local electric grid. Such energy storage systems may sometimes be referred to as grid energy storage systems or stationary energy storage systems. In such an application, electric power from the grid may be used to charge the batteries of the energy storage system when supply exceeds demand (corresponding to a lower energy cost period). This stored energy may then be used to provide (or supplement) power to the installation when demand exceeds supply.

The plurality of batteries of the energy storage system are connected to the electric grid through an inverter. The inverter converts AC current to DC current and vice versa. During a charge cycle of the energy storage system, AC current from the grid is converted to DC current by the inverter and directed to the batteries of the energy storage system. The energy storage system may also include a discharge cycle where DC current from the energy storage system is converted to AC current by the inverter and directed to the grid. In conventional energy storage systems a plurality of batteries may be connected together to a single large inverter. In such systems, the single inverter may convert the DC current from all the batteries to AC current. In such configurations, the electrical performance (for e.g., power output) of the grid storage unit may be limited by the weakest battery of the plurality of batteries. The current disclosure overcomes this or other deficiencies of conventional energy storage systems.

### SUMMARY

Embodiments of the present disclosure relate to, among other things, grid energy storage systems and methods. Each of the embodiments disclosed herein may include one or more of the features described in connection with any of the other disclosed embodiments.

In one embodiment, a scalable energy storage system is disclosed. The energy storage system may comprise a plurality of battery packs including at least a first battery pack and a second battery pack. The system may also include a plurality of inverters. The plurality of inverters may include at least a first inverter and a second inverter. The plurality of battery packs may be electrically coupled to the plurality of inverters such that the first battery pack is individually connected to an input of the first inverter and the second battery pack is individually connected to an input of the second inverter.

In another embodiment, a scalable energy storage system is disclosed. The scalable energy storage system may include a plurality of battery packs and a plurality of inverters. Each battery pack of the plurality of battery packs may be electrically connected to a separate inverter of the plurality of inverters

In yet another embodiment, a method of making a scalable energy storage system is disclosed. The method may include electrically connecting a plurality of battery packs to a plurality of inverters such that each battery pack of the plurality of battery packs is electrically connected to an input of a separate inverter of the plurality of inverters. The method may also include electrically connecting together an output of each inverter of the plurality of inverters.

### BRIEF DESCRIPTION OF THE DRAWINGS

The accompanying drawings, which are incorporated in and constitute a part of this specification, illustrate exemplary embodiments of the present disclosure and together with the description, serve to explain the principles of the disclosure.

FIG. 1 illustrates an energy storage system used to power an electric vehicle charging station;

FIG. 2 illustrates a prior art energy storage system;

FIG. 3 illustrates an exemplary embodiment of the energy storage system of FIG. 1; and

FIG. 4 illustrates another exemplary embodiment of the energy storage system of FIG. 1.

### DETAILED DESCRIPTION

The present disclosure describes an energy storage system associated with an electric vehicle charging station. While principles of the current disclosure are described with reference to a charging station, it should be understood that the disclosure is not limited thereto. Rather, the disclosed energy storage systems and methods may be used in any application.

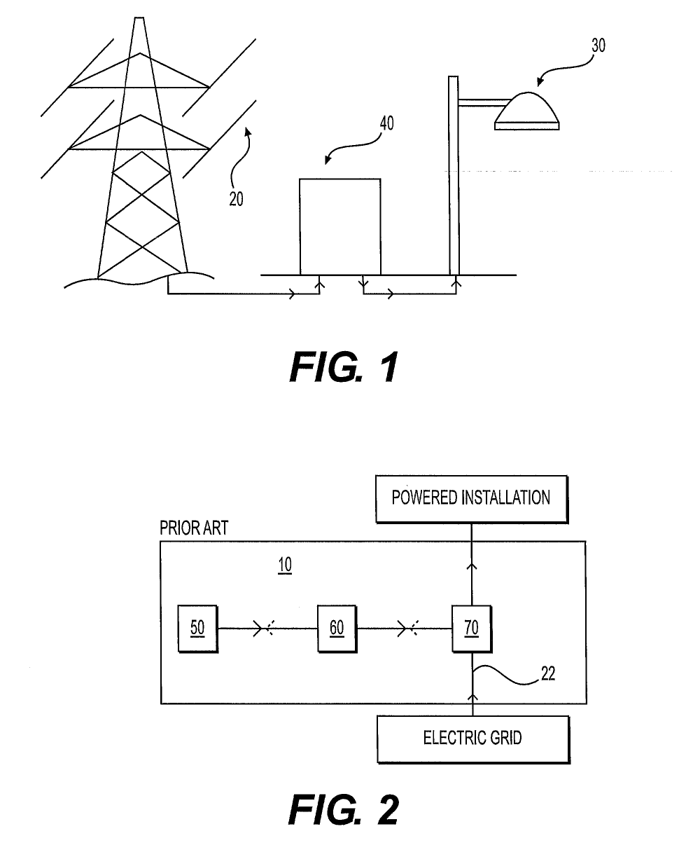

FIG. 1 illustrates an exemplary energy storage system 40 coupled to a charging station 30 connected to an electric grid 20 that supplies power to a locality. Energy storage system 40 may include a cabinet housing a plurality of batteries and other devices (control systems, inverters, switches, circuit breakers, fuses, etc.) that control the power directed to the charging station 30. Charging station 30 may be configured to charge electric vehicles such as, for example, electric transit buses.

FIG. 2 is a schematic illustration of a prior art energy storage system 10. Energy storage system 10 includes a plurality of batteries 50 electrically connected to an inverter 60. The inverter 60 is connected to an electric line 22 that delivers power to an installation (such as charging station 30 of FIG. 1). The controller 70 controls the charging and discharging of the energy storage system. During the charge cycle, power from the grid 20 is used to charge the batteries 50 (as shown by the dashed line arrows), and during the discharge cycle the batteries 50 provide power to the installation (as shown by the solid line arrows).

In the prior art energy storage system 10, each battery of the plurality of battery packs 50 are similar (in terms of chemistry, number of cells, battery health, etc.) to each other. If one of the batteries is weaker than the others (for e.g., lower amount of charge capacity, etc.), the output parameters (power, voltage, current, etc.) of the energy storage system 10 may be limited by the weakest battery. That is, rather than discharging equally, energy will be preferentially discharged from a weaker battery than the healthier batteries of the plurality of batteries 50. This preferential discharge from a weaker battery is the result of impedance changes that occur in a battery with age. Therefore, when scaling up the energy storage system 10 by adding more batteries to the plurality of batteries 50, care must be taken to add batteries that are similar to the existing batteries (of the plurality of batteries 50). This need of finding similar batteries may limit the available options and increase cost because lower cost used batteries from other applications (for e.g., refurbished batteries and used batteries from electric vehicles, etc.) may not be an option.

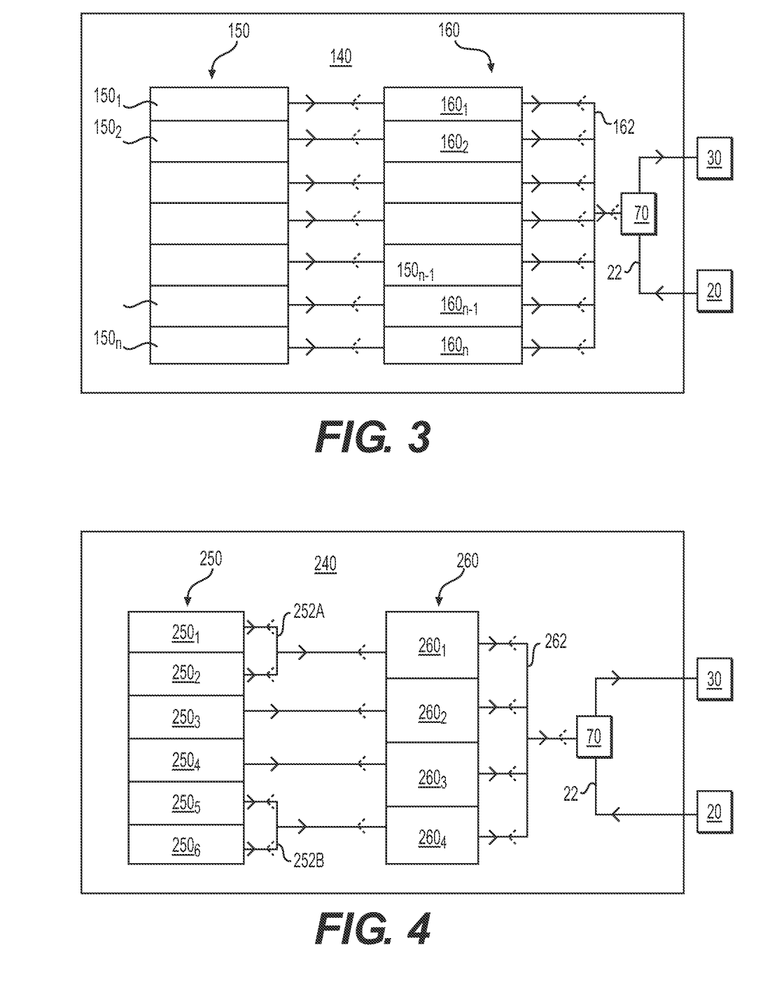

FIG. 3 illustrates an embodiment of an energy storage system 140 of the current disclosure. Energy storage system 140 includes a plurality of battery packs 150 comprising battery packs 150ᵢ (where i=1 to n). Energy storage system 140 also includes a plurality of inverters 160 comprising inverters 160ᵢ (where i=1 to n) electrically coupled together. The output of each battery pack 150ᵢ may be connected to the input of an inverter 160ᵢ. In some embodiments, as illustrated in FIG. 3, each individual battery pack 150ᵢ may be connected to a separate inverter 160ᵢ. On the output side, the inverters 160ᵢ may be connected together in parallel to a bus bar 162. The bus bar 162 is connected to the electric line 22 through a controller 70. It should be noted that, in the description above, the terms output and input are described with reference to the energy storage system 140 during a discharge cycle.

During the discharge cycle, power from the plurality of battery packs 150ᵢ flow towards the charging station 30 (as indicated by the solid line arrows), and during the charge cycle, power from the electric line 22 flows towards the plurality of battery packs 150ᵢ (as indicated by the dashed-line arrows). The power from the plurality of battery packs 150 may be used to charge vehicles at the charging station 30. During the discharge cycle, each inverter 160ᵢ converts the DC current from its connected battery pack 150, to AC current, and during the charge cycle, each inverter 160ᵢ converts AC current from the grid 20 to DC current to charge its connected battery pack 150ᵢ.

Controller 70 may activate and control the charge and discharge cycle of the energy storage system 140. Controller 70 may include memory and logic devices configured to store data and perform arithmetic operations on the data. For example, based on a tariff schedule (table of energy cost at different times) or other variables, the controller 70 may activate the charge and discharge cycle of the energy storage system 140. In some exemplary embodiments, the energy storage system 140 may be charged during times of low energy cost and discharged during times of high energy cost. In some embodiments, during times of high energy cost, the charging station 30 may operate entirely using the power from the energy storage system 140. Alternatively, at such times of high energy cost, a portion of the power (e.g., 50%) may be provided by the electric grid 20 and the remaining portion (i.e., 50%) may be provided by the energy storage system 140.

In some embodiments, each battery pack 150; (i=1−n) of the plurality of battery packs 150 may include one or more batteries electrically connected together in series or parallel. In some embodiments, a battery pack 150ᵢ may include several (10, 9, 8, 7, 6, 5, 4 etc.) batteries connected together in series. In other embodiments, a battery pack 150ᵢ may only include one battery. A battery pack 150ᵢ may include one or more batteries with multiple cells. These multiple cells may be electrically connected together in series or parallel. In some embodiments, some cells of a battery may be connected in series while other cells may be connected in parallel. The cells of a battery may be of any construction (for e.g., cylindrical cell, prismatic cell, button cell, pouch cell construction, etc.).

The batteries of a battery pack 150ᵢ may include any type of batteries known in the art. In general, these batteries may have any chemistry. For instance, these batteries may include, among others, lead-acid batteries, Nickel Cadmium (NiCad) batteries, nickel metal hydride batteries, lithium ion batteries (e.g., lithium titanate), Li-ion polymer batteries, zinc-air batteries molten salt batteries, etc. Some of the possible battery chemistries and arrangements are described in commonly assigned U.S. Pat. No. 8,453,773, which is incorporated herein by reference in its entirety.

Each battery pack 150i of the plurality of battery packs 150 may have a State of Charge (SOC) and a State of Health (SOH). The SOC of a battery is the amount of electric charge contained in the battery. Conceptually, SOC is equivalent to the level of a fuel in the fuel tank of a vehicle. A battery with full charge is considered to have 100% SOC, and a completely drained battery is considered to have 0% SOC. The SOH of a battery is a parameter that reflects the general condition of the battery and its ability to provide power compared with a fresh battery. Conceptually, SOH is equivalent to the size of the fuel tank of a vehicle. During the lifetime of a battery, its SOH (also referred to as health) and performance tends to deteriorate gradually due to age until eventually the battery is no longer usable. This is conceptually similar to the size of a fuel tank reducing with age (due to deposits, etc.). The SOH is an indication of the point in the life of a battery and a measure of its condition (relative to a fresh battery). A battery is considered to have 100% SOH when new and 0% SOH at end of life.

As illustrated in FIG. 3, the DC current from each battery pack 150ᵢ is converted to AC current by a separate inverter 160ᵢ, and output of each inverter 160ᵢ directed to a common bus bar 162. Bus bar 162 may include any type of conductive medium (electrically conductive wire, strip, bar, etc.) that is configured to direct electric current between the plurality of inverters 160 and the electric line 22. Any inverter may be used as inverters 160ᵢ. Each inverter 160, may be the same as, or different from, the other inverters 160ᵢ of the plurality of inverters 160. In some embodiments, microinverters (Enphase M215, Enphase M250, Enphase C250) commercially available from Enphase Energy may be used an inverters 160ᵢ.

Although not a requirement, in some cases, each inverter 160, may have substantially the same power capability as the battery pack 150ᵢ it is associated with (i.e., inverter 160ᵢ is paired with its associated battery pack 150ᵢ). In this disclosure, the terms substantially and about are used to indicate a possible variation of 10%. For example, in an embodiment where battery pack 150₁ has a power of 100 KW and battery pack 150₂ has a power of 150 KW, inverter 160₁ may have a power capability of 100 KW and inverter 160₂ may have a power capability of 150 KW. However, this is not a requirement since using an inverter 160ᵢ of a larger capacity than its associated battery pack 150ᵢ merely under-utilizes the inverter 160ᵢ and using an inverter 160ᵢ of a lower capacity than its associated battery pack 150ᵢ merely makes power conversion slower.

Each battery pack 150ᵢ may be of the same or different type (chemistry, number of batteries, cells, etc.) than other battery packs 150ᵢ of the plurality of battery packs 150. Each battery pack 150ᵢ may also have the same or different SOH and SOC than other battery packs 150ᵢ of the plurality of battery packs 150. In some embodiments, some of the battery packs 150ᵢ may include only one battery while other battery packs 150ᵢ may include multiple batteries. In some embodiments, some of the battery packs 150ᵢ may be lithium titanate battery packs with eight batteries connected in series with each battery having ten cells connected in series, while others may have another chemistry (for example, lead-acid, nickel cadmium, nickel metal hydride, lithium ion, zinc air, etc.) and a different number of batteries and/or cells. In an exemplary embodiment, some of the battery packs 150ᵢ may be 2 year old battery packs from a Chevrolet Volt electric car, while some battery packs 150ᵢ may be new battery packs from Tesla and/or Nissan Leaf electric cars, and the remaining battery packs 150ᵢ may be refurbished 5 year old battery packs from Proterra electric buses.

Unlike prior art energy storage system 10 of FIG. 2, energy storage system 140 may allow battery packs 150ᵢ of different SOC, SOH, chemistries, and types (battery packs from different manufacturers with different powers and different number of batteries, cells, etc.) to be combined together to form a system. Since each battery pack 150ᵢ is directly connected to an inverter 160i, its power output is not affected by the capability and health of other battery packs in the system. Instead, the power output of each battery pack 150ᵢ is only affected by its health and capability. This configuration allows an energy storage system 140 to be formed (and/or scaled up) by coupling together any available battery packs (for e.g., used battery packs from different manufacturers) without affecting the efficiency of the energy storage system 140.

Although energy storage system 140 is illustrated as having an equal number of battery packs 150ᵢ and inverters 160ᵢ, this is not a requirement. FIG. 4 illustrates an embodiment of an energy storage system 240 with an unequal number of battery packs 150ᵢ and inverters 160. Energy storage system 240 includes a plurality of battery packs 250 (with six battery packs 250₁, 250₂, 250₃, 250₄, 250₅, and 250₆) coupled to a plurality of inverters 260 (with four inverters 260₁, 260₂, 260₃, and 260₄). Battery packs 250₁ and 250₂ are connected together in parallel to bus bar 252A which is then connected to inverter 260₁. Similarly, 250₅ and 250₆ are connected together in parallel to bus bar 252B which is then connected to inverter 260₄. The outputs of battery packs 250₃ and 250₄ are connected separately to inverters 260₂ and 260₃. The battery packs may be similar to or different from each other. In some embodiments, the parallel connected battery packs may be substantially similar to each other (same chemistries, number of batteries, cells, SOC, SOH, etc.). That is, battery packs 250₁ may be substantially similar to battery pack 250₂, and battery pack 250₅ may be substantially similar to battery pack 250₆. Battery packs 250₃ and 250₄ may be similar to, or different from, the other battery packs. It should be noted that, although the plurality of battery packs 250 and the plurality of inverters 260 are described as having six battery packs and four inverters respectively, this is only exemplary. In general, the plurality of battery packs 250 may include any number of battery packs, and the plurality of inverters 260 may include any number of inverters.

Similar to energy storage system 140 of FIG. 3, energy storage system 240 may be scaled up by adding additional battery packs to the plurality of battery packs 250. In some cases, additional inverters may also be added to the plurality of inverters 260. If an added battery pack is substantially similar to a preexisting battery pack (a battery pack that is present in the plurality of battery packs 250, for e.g., battery pack 250₃), the added battery pack may be connected together with the preexisting battery pack (250₃), and connected to the inverter (for e.g., 260₂). If the added battery pack is different from the preexisting battery packs, a new inverter may be added to the plurality of inverters 260, and the added battery pack connected to the new inverter.

It should be noted that although battery packs and inverters are illustrated as being separate parts in FIGS. 3 and 4, this is only exemplary. It is contemplated that, in some embodiments, the battery packs and the inverters may be physically integrated into a single part. For example, a battery pack and an inverter may be integrated such that, during discharge, the output of the battery is provided as input to the inverter. In some embodiments, the battery packs and the inverters may be packaged together in a console.

In contrast with prior art energy storage systems, energy storage systems 140 and 240 may be assembled (and scaled up) using battery packs of different types and health. The ability to combine dissimilar batteries used in different applications (e.g., batteries used previously in computer applications with batteries used previously in vehicle applications) in an energy storage system has the potential of substantially reducing the cost of the energy storage system.

For example, if a plurality of batteries were used together as a module in a desktop computer UPS, an inverter sized (e.g., paired) to handle that module can be used form a first battery-inverter pair. This first pair can then be combined with a battery (or batteries) that was used in another application (different computer systems or in a completely different application) to form an energy storage system. If the battery is a battery pack used in a Toyota Prius, an inverter can be paired with this battery pack to form a second battery-inverter pair. This second battery-inverter pair may then be combined with the first battery-inverter pair to form the energy storage system. If 8 battery packs spent their lives together in an electric bus, an inverter can be sized to match the output of the 8 packs together to form a third battery-inverter pair. This third battery-inverter pair may then be combined with the first and second battery-inverter pairs to form the energy storage system. An advantage in all of these cases is that the lowest common denominator for sizing the inverter is the maximum number of batteries used together with a common history in a prior application. Batteries in battery packs having entirely different histories may be uniform in age within themselves. These previously used battery packs can be now used together in one energy storage system in a “second life” application without being constrained by the histories of other battery packs in that system.

In prior art energy storage systems, a plurality of batteries are connected in parallel to a conductor connected to an inverter (i.e., in the prior art, the outputs of the batteries are paralleled to an inverter). In an energy storage system of the current disclosure, the output of each battery (or group of batteries) is connected to an inverter and the outputs of the inverters are then paralleled. Paralleling the outputs of the inverters is much more effective in terms of the ability to combine different battery technologies (different SOHs, SOCs, chemistries, etc.) than paralleling the outputs of the batteries themselves (as in the prior art). Batteries can only be paralleled if they are perfectly matched. Else, the combined system will experience a range of issues due to impedance differences and voltage differences amongst the batteries. “Second life” battery usage is a huge opportunity to extract more value out of battery systems that are past the defined end of life in a weight sensitive application such as automotive vehicle. The systems and methods of the current disclosure enables and/or simplifies the utilization of second life batteries in larger grid tied systems.

While principles of the present disclosure are described with reference to an energy storage system associated with a vehicle charger, it should be understood that the disclosure is not limited thereto. Rather, the systems and methods described herein may be employed in an energy storage system used in any application. Those having ordinary skill in the art and access to the teachings provided herein will recognize additional modifications, applications, embodiments, and substitution of equivalents all fall within the scope of the embodiments described herein. Accordingly, the invention is not to be considered as limited by the foregoing description. For example, while certain features have been described in connection with various embodiments, it is to be understood that any feature described in conjunction with any embodiment disclosed herein may be used with any other embodiment disclosed herein.

1. A scalable energy storage system, comprising:
a plurality of battery packs including at least a first battery pack and a second battery pack, wherein each battery pack of the plurality of battery packs includes a plurality of batteries connected together in series; and
a plurality of inverters including at least a first inverter and a second inverter, the plurality of battery packs being electrically coupled to the plurality of inverters such that the first battery pack is individually connected to an input of the first inverter and the second battery pack is individually connected to an input of the second inverter, and an output of each inverter of the plurality of inverters is electrically connected together, wherein (a) the first battery pack includes a different number of batteries than the second battery pack, and (b) the first battery pack has a different state of health than the second battery pack.

2. The energy storage system of claim 1, wherein each battery pack of the plurality of battery packs is electrically connected to a separate inverter of the plurality of inverters.

3. The energy storage system of claim 1, wherein each battery of the plurality of batteries includes multiple cells.

4. The energy storage system of claim, wherein the first battery pack is a new battery pack and the second battery pack is a refurbished battery pack.

5. The energy storage system of claim 1, wherein the first battery pack is a battery pack of an electric car and the second battery pack is a refurbished battery pack of an electric bus.

6. The energy storage system of claim 4, wherein the first battery pack includes a different chemistry than the second battery pack.

7. (canceled)

8. The energy storage system of claim 4, wherein the first battery pack includes a different state of charge (SOC) than the second battery pack.

9. (canceled)

10. The energy storage system of claim 1, wherein the plurality of battery packs and the plurality of inverters are packaged together in a single module.

11. A scalable energy storage system, comprising:
a plurality of battery packs, wherein each battery pack of the plurality of battery packs includes a plurality of batteries connected together in series; and
a plurality of inverters, wherein each battery pack of the plurality of battery packs is electrically connected to a separate inverter of the plurality of inverters, and an output of each inverter of the plurality of inverters is electrically connected together, wherein each battery pack of the plurality of battery packs have (a) includes a different number of batteries and (b) a different state of health than other battery packs of the plurality of battery packs.

12-13. (canceled)

14. The energy storage system of claim 11, wherein at least one battery pack of the plurality of battery packs has a different state of charge (SOC) than another battery pack of the plurality of battery packs.

15-16. (canceled)

17. The energy storage system of claim 11, wherein at least one battery pack of the plurality of battery packs has a different chemistry than another battery pack of the plurality of battery packs.

18. A method of making a scalable energy storage system, comprising:
electrically connecting a plurality of battery packs to a plurality of inverters such that each battery pack of the plurality of battery packs is electrically connected to an input of a separate inverter of the plurality of inverters, wherein each battery pack of the plurality of battery packs have multiple batteries connected together in series, and each battery pack (a) includes a different number of batteries and (b) a different state of health than other battery packs of the plurality of battery packs; and
electrically connecting together an output of each inverter of the plurality of inverters.

19. (canceled)

20. The method of claim 18, wherein at least one battery pack of the plurality of battery packs has a different state of charge (SOC) than another battery pack of the plurality of battery packs.

21. The energy storage system of claim 11, wherein each battery of the plurality of batteries includes multiple cells.

22. The energy storage system of claim 11, wherein at least one battery pack of the plurality of battery packs is a new battery pack and another battery pack of the plurality of battery packs is a refurbished battery pack.

23. The energy storage system of claim 11, wherein at least two battery packs of the plurality of battery packs are substantially different in age.

24. The energy storage system of claim 11, wherein the plurality of battery packs and the plurality of inverters are packaged together in a single module.

25. The method of claim 18, wherein at least one battery pack of the plurality of battery packs is a new battery pack and another battery pack of the plurality of battery packs is a refurbished battery pack.

26. The method of claim 18, wherein at least two battery packs of the plurality of battery packs are substantially different in age.

27. The method of claim 18, wherein at least two battery packs of the plurality of battery packs have a different chemistry.
